(19) United States
(12) Patent Application Publication
(10) Pub. No.: US 2025/0329476 A1
(43) Pub. Date: Oct. 23, 2025

(54) METHODS AND SYSTEMS FOR FLEXIBLE PULSER ARCHITECTURES FOR PULSED MAGNETIC FUSION SYSTEMS

(71) Applicant: Pacific Fusion Corporation, Fremont, CA (US)

(72) Inventors: Keith Lechien, Fremont, CA (US); Jonathan Fry, Fremont, CA (US); Cory Waltz, Fremont, CA (US); Alex Zylstra, Fremont, CA (US); William Dannemann, Fremont, CA (US); Isaac Kravitz, Fremont, CA (US)

(73) Assignee: Pacific Fusion Corporation, Fremont, CA (US)

(21) Appl. No.: 19/181,791

(22) Filed: Apr. 17, 2025

Related U.S. Application Data
(60) Provisional application No. 63/635,182, filed on Apr. 17, 2024.

(51) Int. Cl. G21B 1/21; G21B 1/05

(52) U.S. Cl. CPC G21B 1/21; G21B 1/05

(57) ABSTRACT

A pulsed magnetic fusion system can include: a plurality of pulse generators, wherein the pulse generators are configured to generate a pulsed electrical current; a fusion target configured to, when disposed within a target chamber, be driven to fusion conditions by an electromagnetic confinement force generated by the pulsed electrical current; a tank comprising a dielectric fluid; and a plurality of pulse tubes, wherein a pulse tube comprises at least a portion of a transmission line configured to connect a pulse generator to the target chamber, wherein the at least the portion of the transmission line is exterior to the tank.

### CROSS-REFERENCE TO RELATED APPLICATIONS

This application claims the benefit of U.S. Provisional Application No. 63/635,182 filed 17 Apr. 2024, which is incorporated in its entirety by this reference.

### TECHNICAL FIELD

This invention relates generally to the inertial fusion field, and more specifically to a new and useful system and method in the inertial fusion field.

### BACKGROUND

Fusion power is a proposed form of power generation that would generate electricity by using heat from nuclear fusion reactions. In a fusion process, two lighter atomic nuclei combine to form a heavier nucleus, while releasing energy. Devices designed to harness this energy are known as fusion systems.

### BRIEF DESCRIPTION OF THE FIGURES

FIG. 1 is an example pulser for a pulsed magnetic fusion system, in accordance with some embodiments.

FIGS. 2A-2C are illustrative examples of constituent elements of a pulser for a pulsed magnetic fusion system, in accordance with some embodiments.

FIG. 3 is an example chamber for a pulsed magnetic fusion system, in accordance with some embodiments. In this example, next to the target 500 and represented as dots, are liquid electrodes. In this example, the top, single-sided arrow represents inflow for heat exchange into the full chamber 300 while the bottom, single-sided arrow represents outflow for heat exchange from the full chamber 300. In this example, the top, double-sided arrow represents evacuation, target insertion, liquid metal for liquid electrodes or flowing liquid walls of the full chamber 300 and/or other components that can be repeatedly introduced into (and removed from either in the same form or different forms) the chamber.

FIG. 4 is an example fusion chamber for a pulsed magnetic fusion system, in accordance with some embodiments.

FIG. 5 is an image of the Z Machine including a blow up of the electronics used for temporal pulse compression (adapted from Sandia's Z Machine at “About Z.” Z Pulsed Power Facility, www.sandia.gov/z-machine/about-z/).

FIG. 6 an image of an IMG-based pulsed magnetic fusion system including a blow up of the electronics used (adapted from Sirius I: Prototype of a Prime-Power Source for Future 1-10 GJ Fusion-Yield Experiments. https://doi.org/10.2172/1962490).

FIG. 7 is an example of an IMG connected to a target via a transmission line using an example of a pulse tube.

FIG. 8A is a top view of an example of a fusion system which use pulse tubes to separate the inner and outer portions of the pulser.

FIG. 8B is a side view of an example of a fusion system which use pulse tubes to separate the inner and outer portions of the pulser.

FIG. 8C is an isometric view of an example of a fusion system which use pulse tubes to separate the inner and outer portions of the pulser.

FIG. 9A is an isometric view of an example of a fusion system which use pulse tubes to separate the inner and outer portions of the pulser. Note that in this specific example, the pulse tubes are omitted for clarity.

FIG. 9B is a side view of an example of a fusion system which use pulse tubes to separate the inner and outer portions of the pulser. Note that in this specific example, the pulse tubes are omitted for clarity.

FIG. 10A is a top view of an example of a fusion system which use pulse tubes to separate the inner and outer portions of the pulser.

FIG. 10B is a side view of an example of a fusion system which use pulse tubes to separate the inner and outer portions of the pulser.

FIG. 10C is an isometric view of an example of a fusion system which use pulse tubes to separate the inner and outer portions of the pulser.

FIG. 11 is an isometric view of an example of a fusion system.

FIG. 12 is a schematic representation of an exemplary pulser arrangement including connections from the pulser to a fusion target.

FIG. 13 is a schematic representation of an exemplary pulse tube.

### DETAILED DESCRIPTION

The following description of the embodiments of the invention is not intended to limit the invention to these embodiments, but rather to enable any person skilled in the art to make and use this invention.

### 1. Overview

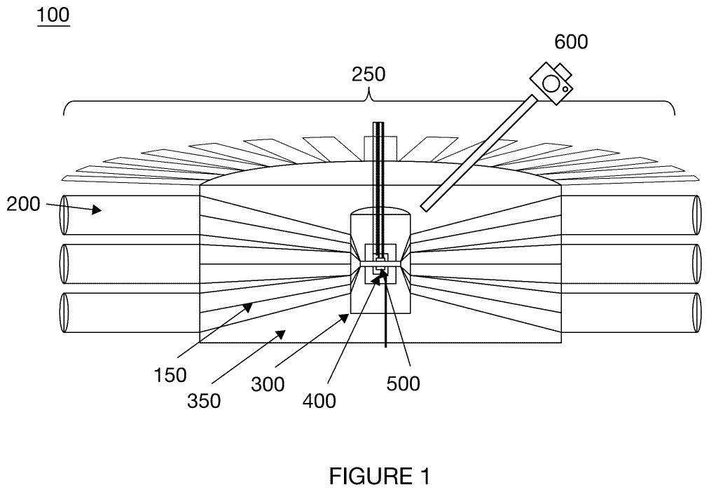

As shown for example in FIG. 1, a pulsed magnetic fusion system 100 can include a pulser 250, a pulser module 200, a transmission structure 150, a full chamber 300, a fusion chamber 400, a fusion target 500, and plasma sensors 600. However, the pulsed magnetic fusion system can include other suitable components.

The pulsed magnetic fusion systems can be used to generate electricity (e.g., operated within a power plant that is grid connected, operated in remote locations that are not grid connected, etc.), retrofit existing power plant(s) (e.g., a power plant that burns coal, natural gas, petroleum, etc. to produce electricity; retrofit a fission power plant; etc.), as a heat source (e.g., a heating interface for industrial processes such as fiberglass manufacture; a heat source for a steam generator for steam cleaning, metal cutting, etc.; water heater and/or water radiator; etc.), as a helium source, as a radiation source (e.g., for high energy photons generated during the fusion reaction such as x-rays), for transportation (e.g., used to power planes, trains, boats, ships, space vehicles, etc. via energy conversion modules configured to generate electrical or mechanical energy), and/or for other suitable application(s). For example, a coal power plant may be retrofitted by replacing a coal-fired boiler with a fusion-driven boiler that utilizes the pulsed magnetic fusion systems disclosed herein. Similarly, a fission power plant may be retrofitted by replacing the fission system with the pulsed magnetic fusion systems disclosed herein. However, the pulsed magnetic fusion systems can be used for other suitable application(s).

### 2. Technical Advantages

Variants of the technology can confer one or more advantages over conventional technologies.

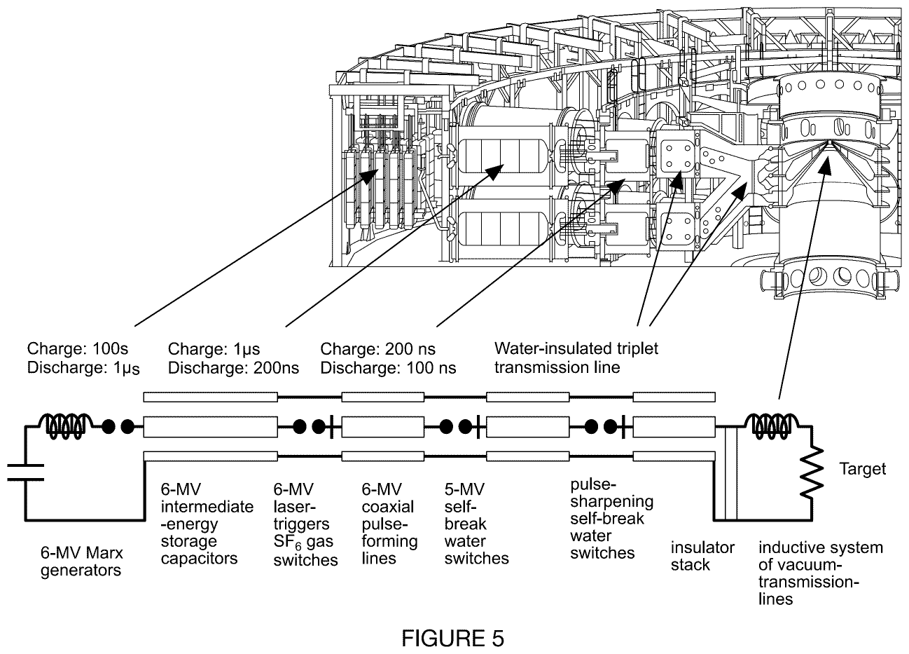

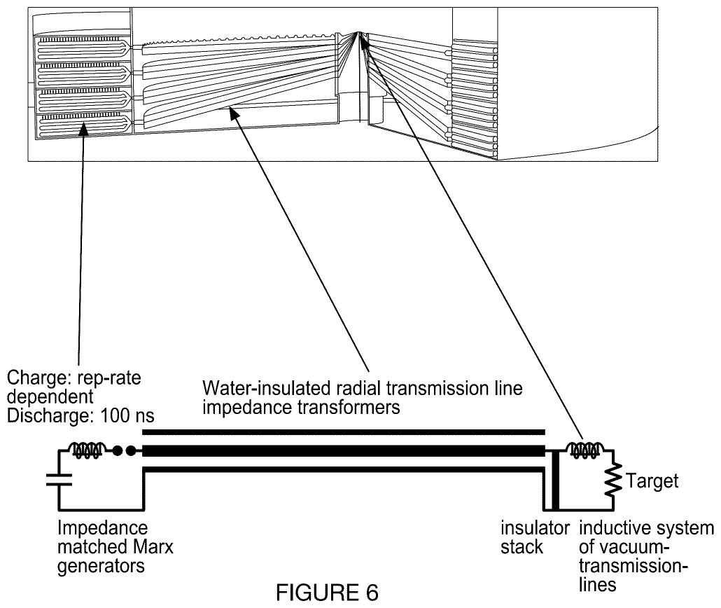

First, variants of the pulsed magnetic fusion systems as disclosed herein can have abundant applications that may help resolve many societal issues, such as dependence on fossil fuels. For example, the configurations for pulsed fusion systems provided can improve size configurability and flexibility over other approaches to fusion (e.g., by introducing modularity; enabling or adjusting height, length, or width considerations or restrictions of the pulsed fusion system, etc.). In contrast, national labs often have largely unlimited size restrictions on building a fusion research facility, whereas for commercial implementation, the pulsed magnetic fusion systems disclosed herein can improve practicality and integration. In practice, the revolved annulus design of Z-machine and of Sirius (as shown for instance in FIG. 5 and FIG. 6) can have several limitations. For example, the pulser in these national lab systems can be quite tall because diagnostic lines of sight are useful to have over the outermost annulus. In commercial systems, height can be a premium dimension for existing hi-bay infrastructure, so taller structures can limit the options for using existing buildings. As another example, the outer dielectric fluid annulus may be one continuous volume (e.g., 3,000,000 gallons) in these national lab facilities. However, the large volume increases the possible environmental impacts of a spill event and can create a need for external fluid storage (e.g., secondary containment matching or exceeding the largest single volume of liquid) during maintenance events. Another limitation in the national lab designs is the closed annulus design is often fully constructed in place, which can force conflicted builds, can limit the ability to build offsite, and can limit assembly modularly (e.g., resulting in challenges removing modules, limit the ability to introduce additional modules, etc.). Transit time isolation of modules may be limited/constrained reducing pulse shaping flexibility. Variants of the pulsed magnetic fusion system as described herein can solved one or more of the deficits in the national lab facility designs and/or can solve other challenges in forming a commercial pulsed magnetic fusion system.

Second, variants of the technology can use pulse tubes to separate the inner and outer portions of the pulser. These designs can, for example, provide at least some of the following advantages: reduced height (e.g., by ˜50% of the annulus architecture); dielectric fluid units reduced in volume (e.g., by factor of about 100); modular construction of modules offsite that could be shipped and installed on site; modules can individually be removed and replaced; intermodule transit time isolation that is fully customizable; the layout scalability to a larger number of modules at any point; and/or other benefits can be provided. For instance, the pulsed magnetic fusion systems disclosed herein can have a modular design that employs a plurality of smaller systems. By having a plurality of systems, the power output of a plant can be modulated to meet energy demand by varying the number of systems (or components thereof) in operation. Additionally or alternatively, when individual systems can be serviced or replaced while other systems remain operable, the overall power output of the plant can not be significantly affected (e.g., the pulser can be oversized, overspeced, etc. so that shutting down a subset of modules does not impact the overall performance).

However, further advantages can be provided by the system and method disclosed herein.

### 3. System

As shown for example in FIG. 1, a pulsed magnetic fusion system 100 can include a pulser 250, a pulser module 200,, a transmission structure 150, a full chamber 300, a fusion chamber 400, a fusion target 500, and plasma sensors 600. However, the pulsed magnetic fusion system can include other suitable components.

The pulser preferably functions to generate a pulsed electrical current, where the pulsed electrical current can be used to drive fusion fuel within a fusion target to fusion conditions. The pulsed electrical current preferably has a duration of order between 100 ns and 1 μs (e.g., 90 ns, 100 ns, 120 ns, 150 ns, 200 ns, 300 ns, 500 ns, 1000 ns, 1500 ns, 2000 ns, 2500 ns, 5000 ns, values or ranges therebetween, etc.). However, shorter or longer pulsed electrical current durations can be used. While the total energy stored by the pulser can depend on the final application, target (e.g., target geometry, target size, target fuel loading, etc.), the fusion yield (or efficiency), a repetition rate, and/or other properties of the fusion system (or components thereof); often the stored energy is on the order of 10-100 MJ (e.g., 9 MJ, 10 MJ, 15 MJ, 20 MJ, 25 MJ, 30 MJ, 50 MJ, 75 MJ, 80 MJ, 90 MJ, 95 MJ, 100 MJ, 110 MJ, 200 MJ, 250 MJ, values or ranges therebetween, etc.). Relatedly, the amount of power the pulser can deliver (e.g., to the target, to the transmission structure, etc.) can be on the order of 10 to 1000 TW (e.g., 20 TW, 50 TW, 75 TW, 100 TW, 150 TW, 200 TW, 300 TW, 350 TW, 400 TW, 500 TW, 600 TW, 750 TW, 900 TW, 1050 TW, values or ranges therebetween, etc.). The repetition rate of the pulsed electrical current can be tuned but is typically on the order of about 0.1 to 10 Hz (e.g., 0.09 Hz, 0.1 Hz, 0.25 Hz, 0.3 Hz, 0.5 Hz, 0.75 Hz, 1 Hz, 1.5 Hz, 2 Hz, 3 Hz, 5 Hz, 7.5 Hz, 8 Hz, 10 Hz, 11 Hz, 15 Hz, values or ranges therebetween, etc.). However, the pulsed electric current can have other suitable properties.

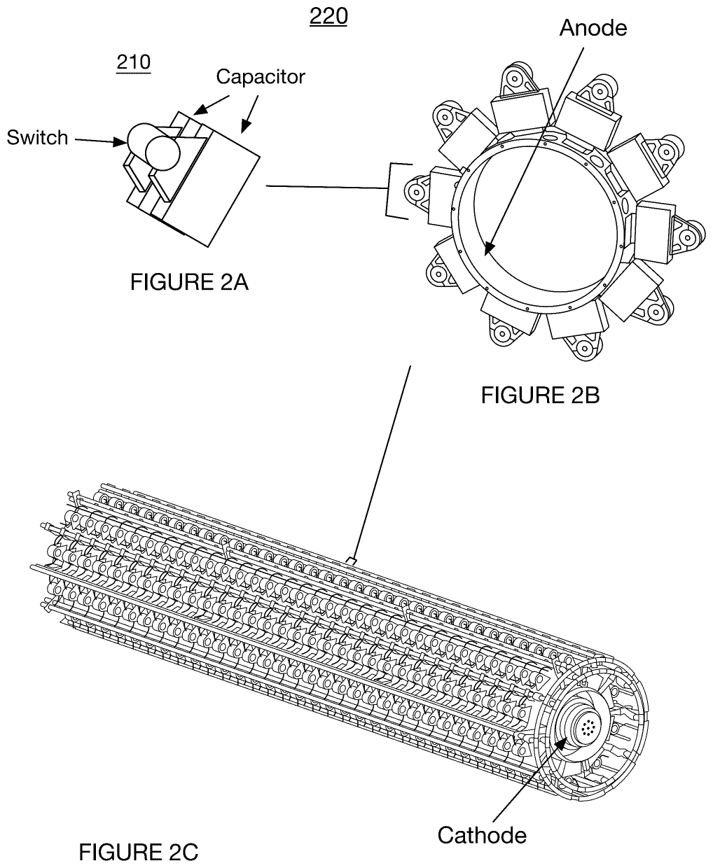

As shown for example in FIG. 2A, FIG. 2B, and FIG. 2C, the pulser 250 can include a plurality of modules 200 (e.g., pulse generators), where each module of the plurality of modules can be formed from a plurality of stages 220, where each stage can be formed from a plurality of bricks 210. Using such a hierarchical approach can be beneficial for enabling modularity in the pulser and can facilitate part replacement and/or installation.

Each brick of the plurality of bricks can include one or more capacitors (e.g., to store and discharge electricity), one or more switches (e.g., to trigger or time charging and/or discharging of the capacitors), and/or other suitable components (e.g., resistors, inductors, etc.). As a specific example (as shown in FIG. 2A), a brick can include two capacitors connected in series with a switch between the two capacitors. However, other brick designs (e.g., with three capacitors connected in series with a switch between each capacitor) could be realized.

Each stage of the plurality of stages is preferably substantially the same as other stages of the plurality (e.g., same size, same shape, same dimensions, same number of bricks, same brick design, etc.). However, in some variants, different stages can be used (e.g., forming a size gradient from larger to smaller stages, forming a size gradient from smaller to larger stages, etc. where larger or smaller can refer to physical size, number of bricks, amount of stored energy, or other relative comparisons between the different stages). In a specific example, each stage can include between 2-20 bricks arranged symmetrically about an outer edge of the stage (e.g., forming an annulus of bricks around an electrode as shown for example in FIG. 2B). However, other stage designs can be used.

Each brick within a stage is preferably arranged in parallel with the other bricks of the same stage. However, some stages can include one or more bricks in series (in addition to and/or alternative to all bricks in parallel). Each brick within a stage is preferably configured to discharged at substantially the same time (e.g., contemporaneously). However, in some variants, bricks can be configured to discharge with different timing (e.g., based on target properties of the final current pulse formed by the pulser).

Each module of the plurality of modules is preferably substantially the same as other modules of the plurality (e.g., same size, same shape, same dimensions, same number of bricks, same brick design, same number of stages, same stage design, etc.). However, in some variants, different modules can be used (e.g., forming a size gradient from larger to smaller modules, forming a size gradient from smaller to larger modules, etc. where larger or smaller can refer to physical size, number of stages, amount of stored energy, or other relative comparisons between the different modules). In a specific example, each module can include between 5-100 stages arranged in series (e.g., forming a line of stages with connected electrodes as shown for example in FIG. 2C). However, other module designs can be used.

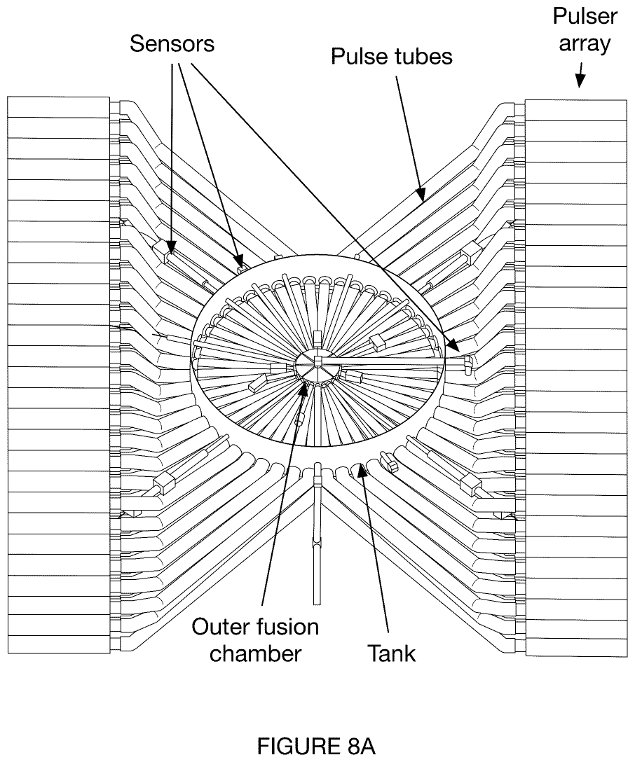

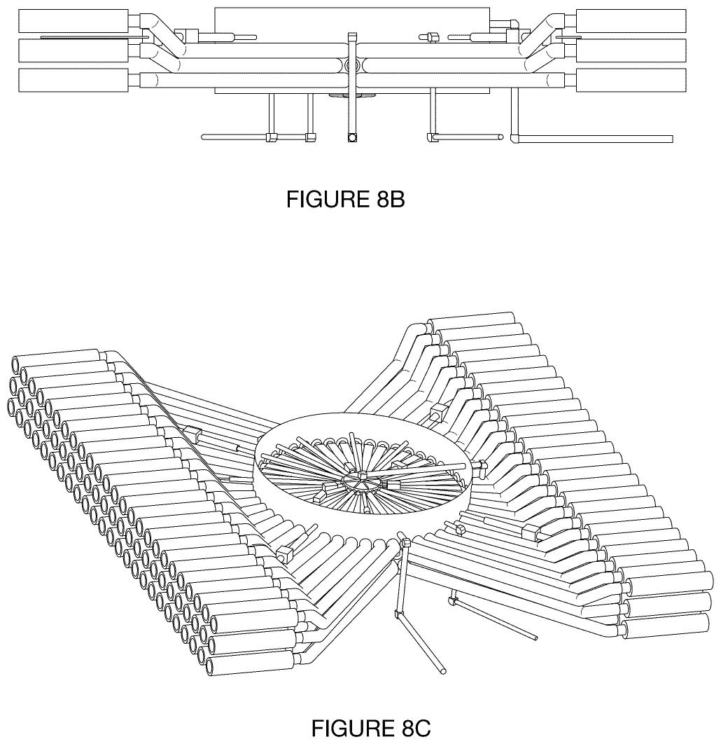

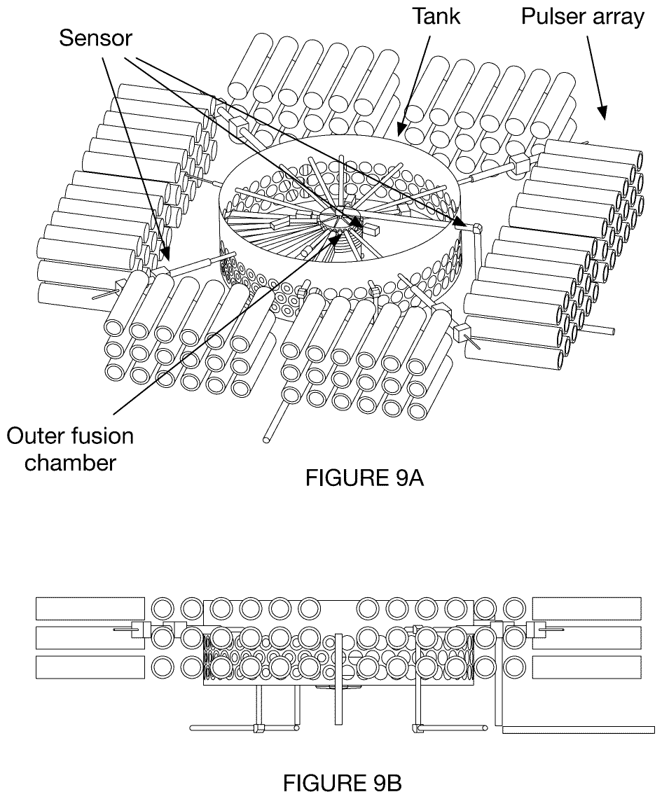

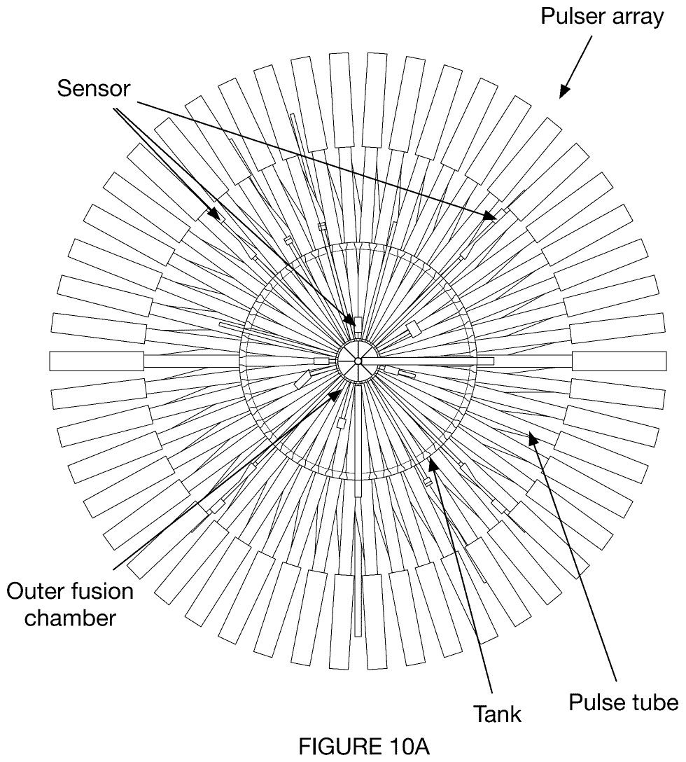

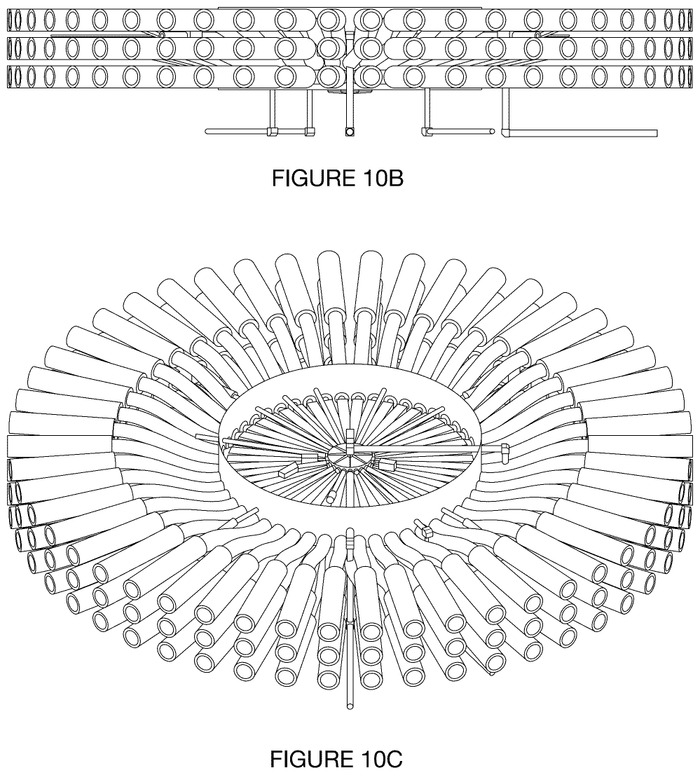

The pulser preferably does not form a closed annulus around the full chamber or fusion chamber. By not forming a closed annulus, accessible space can remain for replacing and/or swapping components as needed (e.g., due to part degradation, dielectric fluid contamination, etc.). For instance, pulsers can surround approximately 180-300° around the chamber(s) (as shown for example in FIG. 8A, FIG. 8C, FIG. 9A). However, the pulsers can be arranged annularly around the full chamber (e.g., as shown for example in FIG. 10A). The pulser is preferably arranged symmetrically about the chamber (e.g., as shown for example in FIG. 8A, FIG. 8C, FIG. 9A, FIG. 10A, FIG. 10C, etc.). However, the pulsers can be arranged asymmetrically about the chamber(s).

The plurality of modules is typically arranged in an array (e.g., on a lattice of module positions). In one example (as shown for instance in FIGS. 8A-8C), the geometry of the array can include two lines of modules arranged on opposing sides of the tank and/or chamber (e.g., thereby forming a rectangular array). In another example, as shown for instance in FIGS. 9A-9B), the geometry of the array can include four lines of modules arranged on four quadrants of the tank and/or chamber (e.g., thereby forming a rectangular array). However, other module array geometries can be used (e.g., a triangular configuration having three lines of modules, a trapezoidal configuration having four lines of modules, a pentagonal configuration having five lines of modules, a hexagonal configuration having six lines of modules, a heptagonal configuration having seven lines of pulse generators, an octagonal configuration having eight lines of pulse generators, a nonagonal configuration having nine lines of pulse generators, a decagonal configuration having ten lines of pulse generators, a configuration having greater than ten lines of pulse generators, and annular arrangement as shown for instance in FIGS. 10A-10C, etc.). Advantageously, certain configurations (e.g., a triangular configuration, a rectangular array configuration, a hexagonal configuration, etc.) can tessellate, enabling separate fusion systems to be located proximate to one another, with a reduced overall footprint. Further advantageously, because each of the arrays can be approximately flat in height (e.g., planar), the arrays can be increased modularly in height to fill areas with higher height restrictions (e.g., to generate more power) or can be decreased modularly in height to fit areas with lower height restrictions.

In a preferred variant, each line of modules preferably has the same number of modules. However, in other variants, one or more lines of modules of all the lines of pulse generators of a fusion system can have a different number of modules. In some cases, each module in the array of modules can be the same diameter. In other cases, one or more modules of the array of modules can have different diameters.

The module arrays are preferably between 1 and 100 (e.g., 1, 2, 3, 5, 7, 9, 10, 20, 30, 40, 50, 60, 70, 80, 90, 100, values or ranges therebetween, etc.) module array geometries high. For example (as shown in FIGS. 8A-8C, FIGS. 9A-9B, FIGS. 10A-10C, FIG. 11, etc.), the pulser can include three lines of modules.

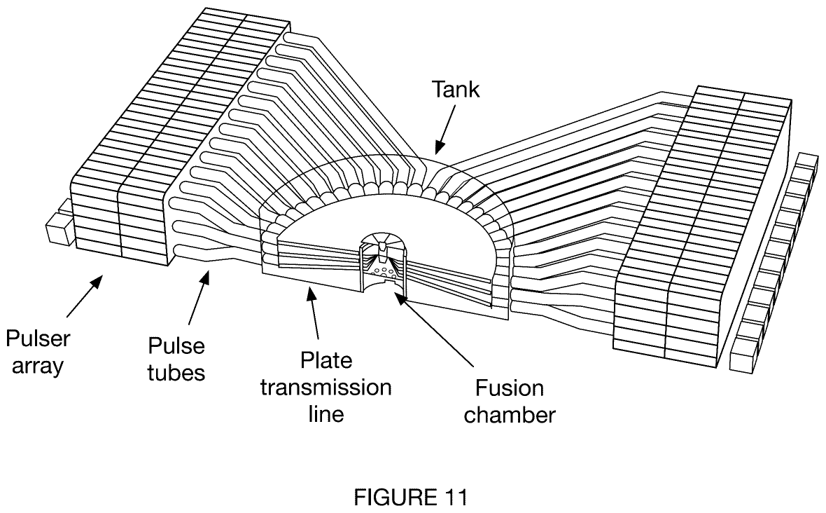

An array of modules can include between 1 and 10,000 modules (e.g., 1, 2, 3, 5, 7, 9, 10, 25, 50, 75, 100, 250, 500, 750, 1000, 2500, 5000, 7500, 10000, values or ranges therebetween, values bounded above or below by one of the aforementioned values, etc.). For example, as shown in FIG. 11, a pulser can include 156 modules in parallel arranged lines of 13 to 30 modules and stacked 3 modules high. However, other arrangements of modules can be used.

The pulser is preferably immersed in a dielectric fluid, where the dielectric fluid can function to hinder or prevent shorting between electrodes (e.g., prevent arcing, corona discharge, etc.), can act to cool (or provide other protection for) the pulser, act as an insulator, attenuate radiation or particles (generated by the fusion event) that escape from the blanket region, and/or can otherwise function. As charging and/or energy storage times can up to order 1 second, the dielectric fluid of the pulser is preferably a dielectric oil (e.g., transformer oil, insulating oil, mineral oil, silicone oil, fluorocarbon oil, pentaerythritol fatty acid esters, nanofluid, vegetable oil, etc.). However, other dielectric fluids could be used. In some variants, the entire pulser can be submerged in a common tank (i.e., the pulser dielectric fluid can be shared between modules and stages). In other variants, a separate tank can be used for each module (e.g., which can be beneficial for having smaller tanks or volumes of dielectric material which can also reduce the scale of secondary containment required, reducing the amount of dielectric material to be drained and/or replaced for replacing a module from the plurality of modules, for facilitating module or stage or brick replacement without requiring other modules to be shutdown, etc.). However, the pulser can otherwise be immersed in (e.g., submerged in) dielectric fluid.

In variants, each module can include between about 100 gallons of dielectric fluid and about 100,000 gallons of dielectric fluid (e.g., 100; 250; 500; 1000; 2500; 5000; 10,000; 25,000; 50,000; 100,000; values or ranges therebetween; bounded by the aforementioned values; etc.). However, the modules can include other suitable amounts of dielectric fluid.

In a preferred embodiment, the pulser can be an array of impedance matched Marx generators (IMGs). An IMG is a pulsed-power device that achieves electromagnetic-power amplification by triggered emission of radiation (e.g., a pulsed-power analog of a laser). As such, an IMG can be modeled as an LCR circuit (e.g., an oscillator). As an illustrative example, the capacitors of an IMG can be charged to high voltage (e.g., the oscillators can be initially in an excited state). Subsequently, switches of the IMG stages can be triggered to launch a coherent traveling wave along the internal axial transmission line of the IMG, where the coherent traveling wave can drive the IMG to achieve electromagnetic-power amplification by triggered emission of radiation. In variations, the power gain of an IMG can be proportional to n, where n is the number of stages.

In a preferred variant, an IMG can achieve an energy efficiency meeting or exceeding 90%. However, additionally or alternatively, the pulser can be an array of Marx generators (e.g., including pulse shaping, pulse compression, etc. to achieve a target pulse shape of the electrical pulse).

In one variant, a building block of an IMG can be a brick (e.g., at least two capacitors connected electrically in series with at least one switch). In this variant, these building blocks can be combined to form a stage, where the stage can include (e.g., be powered by) a single brick or several bricks distributed azimuthally around the stage and connected in parallel. In this variant, an IMG can include a single stage or several stages distributed axially and connected in series. The stages of a multistage IMG can drive an internal axial transmission line (e.g., connected to the transmission structure). The wave impedance of the internal line can be a function of distance along the axial dimension of the line, temperature of the internal line, cross-sectional area of the line, line material, and/or can otherwise be a function of characteristics of the line. The spatial impedance profile of the line is preferably matched to (e.g., differs by at most 10% from) that of the stages that drive the line.

However, an IMG can otherwise be formed.

The IMG concept offers various benefits over Marx generators (sometimes called Marx banks). First, the exemplary Marx generator Z Marx uses SF₆ to insulate gas switches whereas an IMG can use air insulated switches. SF₆ has a greater global warming potential than CO₂ (23,500 times greater) and presents an asphyxiation hazard to accelerator workers. Moreover, each Z-Marx capacitor can store 9400 J and weighs 240 lbs; in contrast, an IMG capacitor can store 800 J and weigh 23 lbs. As such, an IMG capacitor typically requires less time to discharge to a safe energy and can be less likely to be fatal in an operational environment. Furthermore, Z Marx capacitors generate a slower electrical-power pulse than an IMG (in some examples up to 7× slower). Thus, an IMG storing a factor of 6 less energy than a Z Marx can still produce a peak power that exceeds that of the Z Marx by up to 35%. Finally, the temporal width of the electromagnetic-power pulse generated by an IMG can be sufficiently short for the pulse to be transported directly to, and used by, physics loads of interest (e.g., a fusion target), without additional stages of electrical-pulse compression. In contrast to the power pulse generated by an IMG, a Z-Marx pulse can require additional stages of temporal compression before the pulse can be used to drive experiments of interest. However, an IMG can provide other advantages compared to a Marx bank.

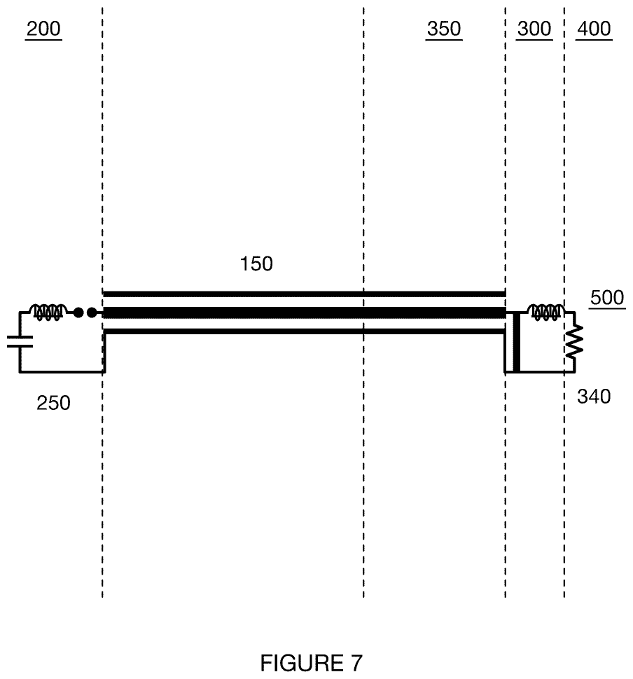

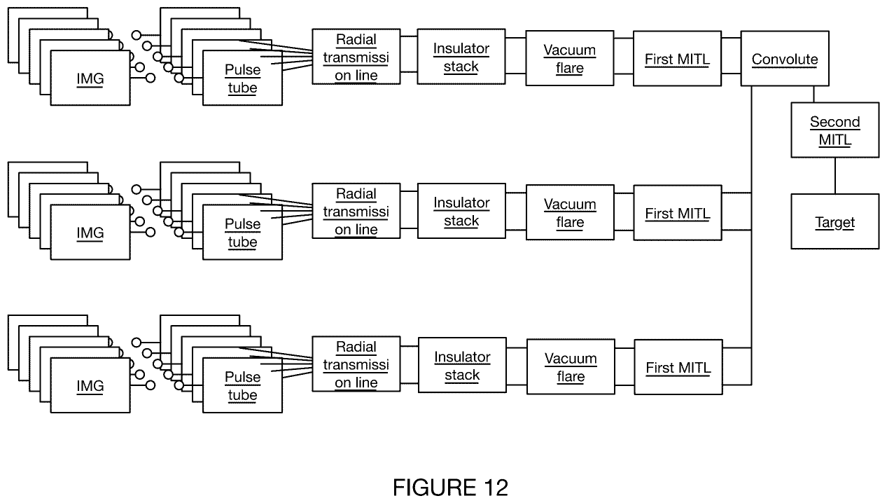

The transmission structure preferably functions to transmit the pulsed electrical current from the pulser to the fusion target (e.g., without substantially modifying or degrading the pulsed electrical current) and/or connect the pulser (or IMGs thereof) to a target (as shown for example in FIG. 7). As shown for example in FIG. 12, the transmission structure can be divided into (e.g., include) a plurality of subregions such as a pulse tube (also referred to as a pulse line) region, a radial transmission region, insulator stack, vacuum flare, magnetically insulating transmission line region (MITL), a convolute, and/or other suitable structures or regions.

The transmission structure(s) (e.g., conducting regions thereof) can be made from copper, silver, gold, aluminium, calcium, tungsten, zinc, nickel, lithium, iron, platinum, tin, carbon steel, lead, titanium, alloys (e.g., manganin, constantan, etc.), stainless steel, and/or other suitable materials (e.g., materials or combinations of materials that exhibit high electrical conductivity, preferably but not necessarily without undergoing reactions with particles or radiation output from a fusion event). The transmission structures can optionally include dielectric materials (e.g., polymers, sheathing, etc.) between electrodes and/or surrounding the transmission structure. In some variants, pulse tubes can be considered a variant of sheathing for a transmission line.

The transmission structure(s) are preferably immersed (e.g., submerged, suspended in, etc.) in dielectric fluid. The dielectric fluid of the transmission structure is typically different from the dielectric fluid of the pulser. Typically a dielectric fluid of the transmission structure has a higher dielectric strength than the dielectric fluid of the pulser. However, the dielectric fluids can have the same dielectric strength (e.g., be the same). The transmission structure dielectric fluid is preferably water (e.g., deionized water, distilled water, tap water, alkaline water, mineral water, spring water, purified water, unpurified water, salt water, ocean water, lake water, river water, well water, ground water, spring water, rainwater, waste water, etc.). However, additionally or alternatively, the transmission structure dielectric fluid can be mineral oil, dielectric oil, vacuum oil, transformer oil, silicone oil, perfluorinated compounds (PFCs), polychlorinated biphenyls (PCBs), nitrogen, helium, argon, sulfur hexafluoride, vacuum, benzene, and/or other suitable dielectric fluid can be used. In some examples, the transmission structure dielectric fluid can be used in a closed system (e.g., with a tank, tube, etc. optionally connected to additional fluid storages). In some examples, the dielectric fluid can be used in an open system (e.g., with the tank, tube, etc. being emptied into the environment, such as, during maintenance). Typically, the pulse tubes and tank regions use the same dielectric fluid composition (but have fluidly isolated dielectric fluid reserves). However, the pulse tubes and tank regions can have different dielectric fluids, can have mixed dielectric fluids, and/or can any suitable dielectric fluid.

In a preferred variant, a first portion of the transmission line (or transmission structure) is exterior to a tank (e.g., that includes dielectric fluid) and contained within a separate tube (e.g., filled with dielectric fluid), and a second portion of the transmission line can be disposed within the tank. However, the transmission structure can otherwise be immersed in dielectric fluid.

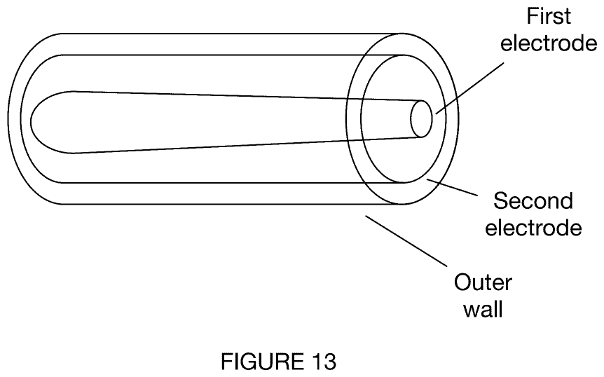

In a preferred variant, each module is preferably connected to a separate transmission structure (where the transmission structures all converge before the target such as at a convolute). In this variant, each transmission structure preferably includes a pulse tube (i.e., a transmission structural region contained within a tube that is fluidly isolated from the transmission structure for other modules, a transmission structural region that is fluidly isolated from the module, a transmission structural region that is fluidly isolated from the tank, etc.). As one specific example, the transmission structural region within the pulse tube can include an inner conductive core (often but not necessarily, acting as the cathode) surrounded by a concentric conducting shield (often, but not necessarily, acting as the anode). In variations of this specific example, an additional concentric conducting shield can be included. As a second specific example (as shown for instance in FIG. 13), each pulse tube can include a first inner electrode (e.g., a cathode, solid electrode wire, tubular electrode, frustoconical tube electrode, prismatic tube, frustopyramidal tube, tapering tube electrode such as with a decreasing diameter from the pulser to the chamber or with an increasing diameter from the pulser to the chamber, etc. where the shape of the electrode can be chosen to mitigate electrical signal reflection and/or interference at junctions) and a second inner electrode (e.g., an anode, tubular electrode, cylindrical electrode, frustoconical tube electrode, prismatic tube electrode, frustopyramidal tube electrode, tapering tube electrode, etc. where the shape of the electrode can be chosen to mitigate electrical signal reflection and/or interference at junctions) that is concentric about the first inner electrode, where the first and second inner electrodes are surrounded by a metal (e.g., stainless steel, aluminium, brass, titanium, etc.) enclosure (e.g., such a cylindrical enclosure, frustoconical tube enclosure, prismatic tube enclosure, frustopyramidal tube enclosure, tapering tube enclosure, etc. that can serve as a tank or container for the dielectric fluid): wherein the first inner electrode, the second inner electrode, and the metal enclosure are each separated by a dielectric fluid (typically the same dielectric fluid but optionally different dielectric fluids can be used). However, other transmission structure designs can be used for the separate regions.

Interfaces between different transmission structure regions (e.g., between each pulse tube and the tank, between a pulse tube and connected module, etc.) are preferably hermetically sealed such that only the electrical pulse travels along or between the regions (but the dielectric fluid is unable to cross or intermix between adjacent regions). Such a design can be advantageous for enabling maintenance and/or installation of individual components without impacting other adjacent components (e.g., without impacting adjacent modules, pulse tubes, etc.; without impacting the tank as a whole and thereby impacting the entire fusion system; etc.). However, interfaces can otherwise be designed.

In one illustrative example, the first portion of the transmission line can be disposed within a pulse tube exterior to the tank. In variations of this illustrative example, the dielectric fluid in the plurality of pulse generators is preferably not fluidically connected to the tank. Further, in some variations, the dielectric fluid in each of the pulse generators of the plurality of pulse generators is preferably not fluidically connected to one another. Accordingly, in variations of this illustrative example, each of the modules and the tank can be non-fluidically connected to one another and each can include a dielectric fluid. For instance, the dielectric fluid comprised in each of the modules and the tank are of different chemical compositions. As the total volume of the dielectric fluid across all of the modules and the tank may be large, there can be substantial savings in time, material, space, labor, etc. in being able to individually drain the pulse tubes or the tank.

In variants, the tank can include between about 10,000 gallons of dielectric fluid and about 100,000,000 gallons of dielectric fluid (e.g., 10,000; 250,000; 500,000; 1,000,000; 2,500,000; 5,000,000; 10,000,000; 25,000,000; 50,000,000; 100,000,000; values or ranges therebetween; bounded by the aforementioned values; etc.). However, the tank can include other suitable amounts of dielectric fluid.

In variants, each pulse tube can include between about 100 gallons of dielectric fluid and about 100,000 gallons of dielectric fluid (e.g., 100; 250; 500; 1000; 2500; 5000; 10,000; 25,000; 50,000; 100,000; values or ranges therebetween; bounded by the aforementioned values; etc.). However, the pulse tubes can include other suitable amounts of dielectric fluid.

In some variants (e.g., as shown for example in FIG. 8A, FIG. 8B, and FIG. 8C), the pulse tubes can allow the modules of the pulser (e.g., pulse generator array) to be disposed at varying distances from the tank. The difference in length of pulse tubes between the shortest pulse tube and the longest pulse tube can be about 5%, about 10%, about 25%, about 50%, about 75%, about 100%, about 150%, about 200%, about 300%, about 400%, about 500%, about 1000%, a value or range therebetween, and/or other suitable length difference (where the length difference can be corrected for or compensated for using a controller without requiring significant additional electrical equipment such as pulse modulator).

In some variants (e.g., as shown for example in FIG. 9A and FIG. 9B), the pulse tubes can have similar (e.g., the same, differing by less than about 5%, etc.) lengths. In these variants, firing of electrical pulses through the pulse tubes may be coordinated such that the electrical pulses all arrive to the fusion chamber (e.g., affecting the fusion target) contemporaneously (e.g., by firing the electrical current in each module simultaneously).

In some variants (e.g., as shown for example in FIG. 10A, FIG. 10B, and FIG. 10C), the pulse tubes can have similar (e.g., the same, differing by less than about 5%, etc.) lengths. In this variant, the pulse tubes can form an annular array about the chamber and/or tank.

In some cases, the diameter of each pulse tube can be between about 0.5 m and about 20 m (e.g., 1 m, 2 m, 5 m, 10 m, 15 m, 20 m, values or ranges therebetween, values bounded above or below by an aforementioned value, etc.).

In a preferred example, as shown for example in FIG. 12, the electric pulse from each line or array of modules is transmitted via a transmission line (e.g., pulse tube with separate supply containers of dielectric fluid) to a shared plate transmission line (e.g., disposed within a tank), where different arrays of transmission modules are initially connected to distinct plate transmission lines (e.g., radial transmission line or region, where the plate transmission lines are all disposed within a shared tank of dielectric fluid). To reach the target, the radial transmission lines can each connect to separate (or potentially to a shared) magnetically insulating transmission line (MITL). At the interface between the radial transmission line and the MITL, an insulator stack (e.g., vacuum flare) can separate (e.g., hermetically seals) the dielectric fluid tank from the vacuum surrounding the MITL (e.g., to maintain a vacuum of the chamber). In variations where the MITLs are separate, a convolute (e.g., with a number of holes matching the number of levels of module arrays) can be used to combine the electrical signals from each MITL. Finally, a second MITL can be used to transport the electrical pulse the final distance to the target. However, other designs can be used for the transmission structure.

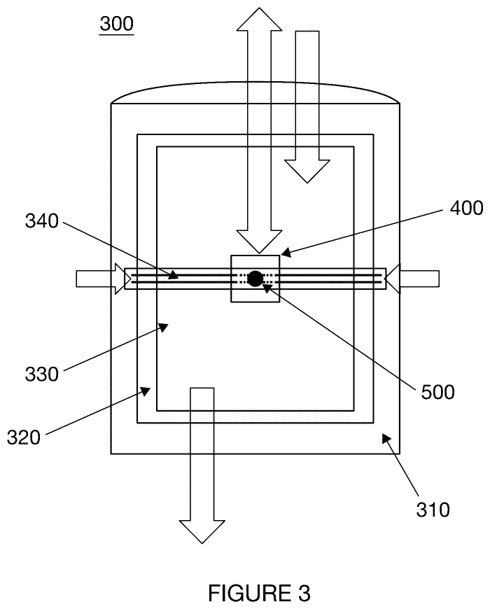

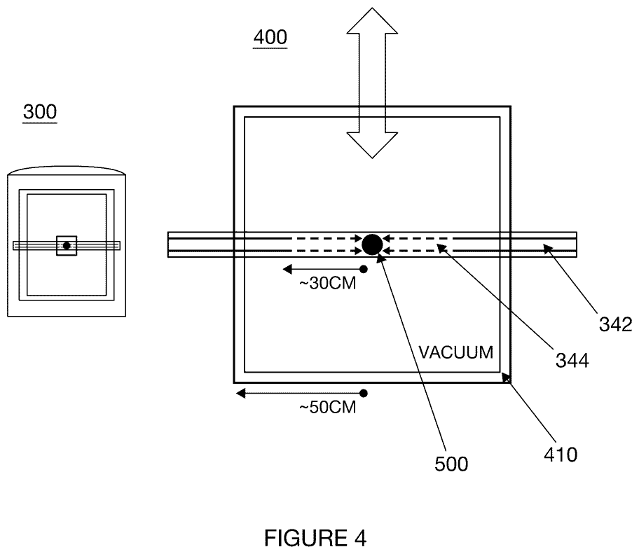

The chamber preferably acts as a location where nuclear fusion events can occur (e.g., contain a burst of energy from a fusion event, capture energy from the fusion event, serve as a location for tritium breeding, etc.). As shown for example in FIG. 3, the full chamber 300 can include an outer vacuum chamber 310 where energy pulses from each of the modules are transmitted radially inward via the transmission structure. The outer vacuum chamber can have a radius of between about 0.1 meters and 10 meters (e.g., 0.1 m, 0.2 m, 0.5 m, 1 m, 2 m, 5 m, 10 m, values or ranges therebetween, etc.); however, others suitable vacuum chamber sizes can be used. In a preferred variant, the outer vacuum chamber can be surrounded by a tank of dielectric material (e.g., dielectric material that transmission structure is immersed in particularly that around the radial transmission lines), where the dielectric material can provide an additional layer of insulation and/or shielding for the chamber. Additional shielding 320 can optionally be included (e.g., to capture neutrons or photons that escape a blanket 330). The additional shielding 320 can include various materials, such as one or more of tungsten carbide, tungsten boride, titanium hydride, and/or other suitable materials.

The blanket 330 can function to shield external components (i.e., external relative to the fusion chamber being internal the blanket), to breed tritium, act as a heat exchange fluid to move fusion energy output to a heat engine, and/or can otherwise function. The blanket 330 can be a solid (e.g., pebble bed) blanket and/or a liquid blanket. The blanket may include various materials, such as one or more of lithium tetrafluoroberyllate (FLiBe, Li₂BeF₄), lead-lithium alloy (PbLi), Li, lithium titanate (e.g., Li₂TiO₃, Li₄Ti₅O₁₂, Li₇Ti₅O₁₂, Li₄TiO₄, Li₂Ti₃O₇, etc.), lithium silicates (e.g., Li₂SiO₃, Li₄SiO₄), and/or other suitable materials (particularly those enriched with ⁶Li). In some variants, the blanket 330 can be split into two or more sections (e.g., to allow for easier passage of solid electrodes into the inner vacuum, to allow to easier repair or replacement, etc.). The blanket 330 can have a thickness between about 0.1 meters and about 10 meters (e.g., 0.1 m, 0.2 m, 0.5 m, 1 m, 2 m, 5 m, 10 m, values or ranges therebetween, etc.).

The full chamber 300 can include (e.g., surround, encompass, etc.) the fusion chamber 400, where the fusion chamber can function as the chamber where the fusion event occurs (i.e., where a target 500 is driven to fusion conditions). The fusion chamber can have a size between about 0.1 meters and about 10 meters (e.g., 0.1 m, 0.2 m, 0.5 m, 1 m, 2 m, 5 m, 10 m, values or ranges therebetween, etc.).

The fusion chamber can include a fusion chamber wall 410. The fusion chamber wall 410 can have a radius of between about 0.1 meters and about 10 meters (e.g., 0.1 m, 0.2 m, 0.5 m, 1 m, 2 m, 3 m, 4 m, 5 m, 10 m, etc.). The fusion chamber wall 410 can have a height of between about 0.1 meters and about 10 meters (e.g., 0.1 m, 0.5 m, 1 m, 2 m, 3 m, 4 m, 5 m, 10 m, etc.). The fusion chamber wall 410 can be replaceable (e.g., at a frequency such as daily, weekly, monthly, quarterly, annually, etc.). The fusion chamber wall 410 can include a structural material, such as steel or titanium alloy. The fusion chamber wall 410 can be coated, such as with one or more of tungsten, silicon carbide, a flowing liquid metal, and/or other material to resist the fusion impact conditions.

The target 500 preferably functions to store fusion fuel (e.g., a mixture of ²H and ³H, ²H, ²H and ³He, ¹H and ¹¹B, ²H and ¹¹B, ³H and ¹¹B, etc.), where when the pulsed electrical signal passes through the target the fuel experiences conditions (e.g., confinement forces, magnetic fields, temperatures, etc.) to drive the fusion fuel to undergo fusion. The target can be cylindrical, spherical, spheroidal, hemispheroidal, prismatic, polyhedral, and/or can have other suitable shape. The target 500 can have a size (e.g., largest or smallest geometric extent along one or more axes) between about 0.1 cm and 10 cm (e.g., 0.1 cm, 0.2 cm, 0.5 cm, 1 cm, 2 cm, 3 cm, 4 cm, 5 cm, 10 cm, values or ranges therebetween, etc.).The target 500 is typically replaced after every shot (e.g., at about 0.1 Hertz, 0.5 Hertz, 1 Hertz, 2 Hertz, 3 Hertz, 4 Hertz, 5 Hertz, 10 Hertz, etc.). However, a single target could be reused for subsequent shots (e.g., for a predetermined number of shots, until a threshold amount of fuel is consumed, etc.).

The transmission structure can connect to the target via electrodes in the chamber. In some variants, the electrodes 340 can be solid electrodes (e.g., made from metal or other conductive material), where the solid electrodes are connected to the transmission structure (e.g., at a MITL). For example, The electrodes 340 can include an anode (e.g., the top electrode) and a cathode (e.g., the bottom electrode). The electrodes can be replaced at a frequency (e.g., daily, weekly, monthly, quarterly, annually, etc.). In another variant, the electrodes (e.g., as shown for example in FIG. 3) can include a solid electrode and a liquid electrode jet (e.g., made from molten metal, ionic liquid, high salt concentration, etc.). In this variant, the solid electrodes 342 can penetrate an inner wall of the fusion chamber 400 (e.g., by about 0.5 centimeters, 1 centimeter, 2 centimeters, 3 centimeters, 4 centimeters, 5 centimeters, 10 centimeters, 20 centimeters, 50 centimeters, 100 centimeters, etc.). The liquid electrodes 344 can have a radius between about 0.1 centimeters and about 100 centimeters (e.g., 0.1 cm, 0.2 cm, 0.5 cm, 1 cm, 2 cm, 3 cm, 4 cm, 5 cm, 10 cm, 20 cm, 30 cm, 50 cm, 100 cm, etc.).

In some variants, the pulsed magnetic fusion system can include a controller (and/or more general computing system) that can function to control the firing and/or timing of the pulser. Typically, the modules are configured to fire substantially contemporaneously (e.g., so that the electrical signals additively combine, where substantially can account for timing differences resulting from differences in transmission structure length between different modules of the pulser). However, the modules can fire sequentially (e.g., to produce longer confinement times such as on the order of us). As a first example, firing of electrical pulses through the pulse tubes can be coordinated using a controller such that the electrical pulses all arrive to the fusion chamber (e.g., affecting the fusion target) simultaneously or contemporaneously. In the first example, the controller can fire the electrical pulse in descending order of pulse tube length (e.g., the longer pulse tubes have an electrical pulse initiated before the shorter pulse tubes). As a second example, each module can include driving circuitry configured to control an arrival time of the pulsed electrical current (e.g., relative to other modules). Additionally or alternatively, the controller can control cooling characteristics of each module and/or pulse tube, and/or can control other suitable aspects of the pulsed magnetic fusion system.

The pulsed magnetic fusion system preferably includes a sensor suite (i.e., one or more sensor(s)) for monitoring properties of the plasma generated within the fusion chamber and/or for monitoring the pulser (or components thereof) behavior. The sensors are generally outside of the fusion chamber (as they can be susceptible to damage within the chamber). The pulse tubes can offer an advantage of allowing flexibility in arranging sensors within the pulsed magnetic fusion system. As shown for example in FIG. 8A, FIG. 9A, FIG. 10A, one or more sensors can be arranged between pulse tubes, above pulse tubes, below pulse tubes, mounted to the tank, and/or can otherwise be arranged relative to the transmission structure. In some variants, positioning of sensors far from Target Chamber Center (TCC) (e.g., outside of the tank) can provide a technical advantage of improving spectral resolution and/or spatial resolution of the measured sensor data. In some variants, optical relays can be coupled to the sensors (e.g., to minimize the space occupied by diagnostic sensors and/or increase the shielding of the tank). Example sensors that can be accommodated include: neutron imaging sensors (e.g., neutron time of flight (NTOF) sensors, Energetic Neutron Detectors Observing with Resolution (ENDOR), etc.), nuclear diagnostic sensors (e.g., DT γ-ray reaction history measured by a Compton Electron cherenKOV (CEKOV) detector, DD nuclear burn history measurements based on a Recoil Ion DEtector (RIDE), (n,γ) Cherenkov detection (NGC), a MAgnetic Recoil Spectrometer (MARS) for estimating neutron yield and spectrometry, Activation Samples for Thermonuclear Reaction Analysis (ASTRA), etc.), x-ray diagnostic sensors (e.g., emitted power measurement using a Calibrated Radiometry and Bolometry (CRAB) diagnostic using a filtered streak camera, equatorial orthogonal x-ray cameras for self-emission imaging, Gated Active Long Aspect X-ray Imager (GALAXI), Versatile Imaging for RadioGraphic Observations (VIRGO), an x-ray Spectroscopic Instrument for Collisional Excitation (SPICE) potentially with several crystals for key energy ranges, etc.), optical diagnostics (e.g., FAraday Rotatation and Deflectometry (FARAD) in low-density near-target plasmas, a line VISAR for drive characterization and materials studies, fiber-coupled photon Doppler velocimetry (PDV), etc.), and/or other suitable sensors can be used. The sensors are typically arranged in the equatorial plane (e.g., with common sensors in orthogonal positions to best diagnose spectral moments, for improved 3D reconstruction, etc.). However, sensors can be arranged in axial positions and/or can otherwise be positioned.

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Many techniques have been proposed to achieve net fusion energy gain, ultimately for the purposes of a useful power source. One subset of these techniques is pulsed fusion, in which systems drive high-gain fusion events at a certain frequency. A subset of pulsed fusion is pulsed magnetic fusion, in which large electrical energy pulses are used to magnetically compress and heat fusion targets (assemblies of fusion fuel, often contained within a liner/container) to net-positive energy gain. For example, the Z Machine at Sandia National Laboratories has been used to drive pulsed fusion experiments, including pulsed magnetic fusion (e.g., MagLIF).

Systems, methods, and techniques disclosed herein use impedance-matched Marx generators (IMGs), such as described in (1) Stygar, W. A., LeChien, K. R., Mazarakis, M. G., Savage, M. E., Stoltzfus, B. S., Austin, K. N., Breden, E. W., Cuneo, M. E., Hutsel, B. T., Lewis, S. A., McKee, G. R., Moore, J. K., Mulville, T. D., Muron, D. J., Reisman, D. B., Sceiford, M. E., & Wisher, M. L. (2017). Impedance-matched Marx generators. Physical Review Accelerators and Beams, 20(4). https://doi.org/10.1103/physrevaccelbeams.20.040402 or (2) LeChien, K., Stygar, W., Anderson, M., Max, D., Anaya, R., Beatty, C., White, A., Trueblood, J., Benson, A., Beverly, R., Chaffee, R., Cortes, J., Drews, W., Hicks, R., Howland, F., Norton, D., Speer, R., & Watson, J. (2023). Sirius I: Prototype of a Prime-Power Source for Future 1-10 GJ Fusion-Yield Experiments. https://doi.org/10.2172/1962490), each of which is incorporated by reference herein in its entirety. The systems, the methods, and the techniques disclosed herein use IMGs to drive pulsed magnetic fusion targets (e.g., fusion targets driven by magnetic compression resulting from a pulsed electrical current) to high gain or ignition.

Different subsystems and/or modules discussed above can be operated and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, and/or FPGA/ASIC. However, the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out.

The terms “about” or “approximately” and/or other words of approximation (e.g., “substantially”) can mean within an acceptable error range for the particular value, which will depend in part on how the value is measured or determined, e.g., the limitations of the measurement system. For example, “about” can mean within 1 or more than 1 standard deviation, per the practice in the art. Alternatively, “about” can mean a range of up to 20%, up to 10%, up to 5%, or up to 1% of a given value. Where particular values are described in the application and claims, unless otherwise stated the term “about” meaning within an acceptable error range for the particular value can be assumed.

As a person skilled in the art will recognize from the previous detailed description and from the figures and claims, modifications and changes can be made to the preferred embodiments of the invention without departing from the scope of this invention defined in the following claims.

### Illustrative Examples

A numbered list of specific examples of the technology described herein are provided below. A person of skill in the art will recognize that the scope of the technology is not limited to and/or by these specific examples.
1. A pulsed magnetic fusion system, comprising: a plurality of pulse generators, wherein said plurality of pulse generators are configured to generate a pulsed electrical current; a fusion target configured to, when disposed within a target chamber, be driven to fusion conditions by an electromagnetic confinement force generated by said pulsed electrical current; a tank comprising a dielectric fluid; and a plurality of pulse tubes, wherein a pulse tube of said plurality of pulse tubes comprises at least a portion of a transmission line configured to connect a pulse generator of said plurality of pulse generators to said target chamber, wherein said at least said portion of said transmission line is exterior to said tank.
2. The pulsed magnetic fusion system of specific example 1, wherein said plurality of pulse generators comprises a plurality of impedance-matched Marx generators (IMGs).
3. The pulsed magnetic fusion system of any of specific examples 1-2, wherein said dielectric fluid is configured to electrically insulate said plurality of pulse generators.
4. The pulsed magnetic fusion system of any of specific examples 1-3, wherein said plurality of pulse generators are configured to be cooled by a dielectric fluid, wherein said dielectric fluid is not fluidically connected to said tank.
5. The pulsed magnetic fusion system of any of specific examples 1-4, wherein said plurality of pulse generators are arranged in an array, and wherein a geometry of said array is not annular.
6. The pulsed magnetic fusion system of any of specific examples 1-5, wherein said plurality of pulse generators are arranged in an array, and wherein a geometry of said array is rectangular.
7. The pulsed magnetic fusion system of any of specific examples 1-3, wherein said plurality of pulse generators are arranged in an array, and wherein said array comprises a plurality of modular regions, wherein each modular region is configured to be cooled by additional dielectric fluid.
8. The pulsed magnetic fusion system of specific example 7, wherein said additional dielectric fluid in said each modular region of said plurality of modular regions is (i) not fluidically connected to said dielectric fluid in said tank and (ii) not fluidically connected to said additional dielectric fluid in at least one other modular region of said plurality of modular regions.
9. The pulsed magnetic fusion system of any of specific examples 7-8, wherein said additional dielectric fluid in said each modular region of said plurality of modular regions is configured to be separately drained from said additional dielectric fluid in said at least one other modular region of said plurality of modular regions.
10. The pulsed magnetic fusion system of any of specific examples 7-9, wherein each modular region of said plurality of modular regions comprises a plurality of replaceable pulse generators, wherein each of said plurality of replaceable pulse generators are configured to be changed without draining said dielectric fluid from said tank or said additional dielectric fluid in said at least one other modular region of said plurality of modular regions.
11. The pulsed magnetic fusion system of any of specific examples 7-10, wherein each modular region of said plurality of modular regions is of a size smaller than a standard shipping container.
12. The pulsed magnetic fusion system of any of specific examples 7-11, wherein each modular region of said plurality of modular regions is of a size approximately of a standard shipping container.
13. The pulsed magnetic fusion system of any of specific examples 7-12, wherein each modular region of said plurality of modular regions is configured to be separately removeable from operation or connectable to operation to alter a power delivered to said fusion target.
14. The pulsed magnetic fusion system of any of specific examples 7-13, wherein each modular region of said plurality of modular regions comprises a driving circuitry configured to control an arrival time of said pulsed electrical current.
15. The pulsed magnetic fusion system of any of specific examples 7-14, wherein cooling characteristics of each modular region of said plurality of modular regions are separately controllable.
16. The pulsed magnetic fusion system of any of specific examples 1-15, wherein said transmission line is water-insulated.
17. The pulsed magnetic fusion system of any of specific examples 1-16, wherein said dielectric fluid is configured to capture or attenuate neutrons or high-energy photons resulting from said fusion event.
18. The pulsed magnetic fusion system of any of specific examples 1-17, wherein another portion of said transmission line is interior to said tank.
19. A pulsed magnetic fusion system, comprising: an inner pulser; and an outer pulser comprising a plurality of pulse tubes, wherein said outer pulser is positioned non-annularly around said inner pulser, and wherein at least a portion of said plurality of pulse tubes each comprise a dielectric fluid.
20. The pulsed magnetic fusion system of specific example 19, wherein said inner pulser is around a fusion chamber.
21. The pulsed magnetic fusion system of any of specific examples 19-20, wherein said plurality of pulse tubes comprise a first set of pulse tubes and a second set of pulse tubes, wherein said first set of pulse tubes is mutually exclusive from said second set of pulse tubes.
22. The pulsed magnetic fusion system of any of specific examples 19-21, wherein: (i) each pulse tube of said first set of pulse tubes is positioned adjacent to at least one other pulse tube of said first set of pulse tubes; (ii) each pulse tube of said second set of pulse tubes is positioned adjacent to at least one other pulse tube of said second set of pulse tubes; and (iii) the central axis of each pulse tube of said first set of pulse tubes and the central axis of each pulse tube of said second set of pulse tubes are positioned parallel to each other.
23. The pulsed magnetic fusion system of specific example 22, wherein the central axis of each pulse tube of said first set of pulse tubes and the central axis of each pulse tube of said second set of pulse tubes are positioned perpendicular to each other.
24. The pulsed magnetic fusion system of any of specific examples 19-23, wherein a first pulse tube of said plurality of pulse tubes has a difference in length from a second pulse tube of said plurality of pulse tubes.
25. The pulsed magnetic fusion system of specific example 24, further comprising: a controller configured to compensate for said difference in length between said first pulse tube of said first plurality of pulse tubes and said second pulse tube of said second plurality of pulse tubes.
26. The pulsed magnetic fusion system of any of specific examples 19-25 ,wherein said plurality of pulse tubes comprise at least 5 pulse tubes.
27. The pulsed magnetic fusion system of specific example 26, wherein said plurality of pulse tubes comprise at least 100 pulse tubes.
28. The pulsed magnetic fusion system of specific example 27, wherein said plurality of pulse tubes comprise at least 500 pulse tubes.
29. The pulsed magnetic fusion system of any of specific examples 19-28, wherein each of said plurality of pulse tubes comprise an impedance matched Marx generator.
30. A pulsed magnetic fusion system, comprising: a pulser configured to generate a pulsed electrical current; a transmission line electrically connecting the pulser to a fusion chamber, wherein the transmission line comprises a pulse tube region and a plate (e.g., disk) transmission region; and a fusion target comprising a fusion fuel, wherein when the fusion target is disposed within the fusion chamber and the fusion target is compressed by an electromagnetic force generated by the pulsed electrical current, driving the fusion fuel to fusion conditions.
31. The pulsed magnetic fusion system of specific example 30, wherein the pulser comprises a plurality of impedance-matched Marx generators (IMGs).
32. The pulsed magnetic fusion system of any of specific examples 30-31, wherein each IMG of the plurality of IMGs is connected to a separate pulse tube of the pulse tube region of the transmission line.
33. The pulsed magnetic fusion system of any of specific examples 30-32, wherein each pulse tube comprises a first inner electrode and a second inner electrode that is concentric about the first inner electrode, wherein the first and second inner electrodes are surrounded by a metal enclosure: wherein the first inner electrode, the second inner electrode and the metal enclosure are each separated by a dielectric fluid.
34. The pulsed magnetic fusion system of specific example 33, wherein the dielectric fluid is purified (e.g., deionized) water.
35. The pulsed magnetic fusion system of any of specific examples 33-34, wherein the pulser is immersed in a second dielectric fluid that is different from the dielectric fluid of the pulse tubes.
36. The pulsed magnetic fusion system of specific example 35, wherein the second dielectric fluid is a dielectric oil.
37. The pulsed magnetic fusion system of any of specific examples 35-36, wherein the pulser and each pulse tube are electrically coupled at a seal preventing fluid communication between the dielectric fluid and the second dielectric fluid.
38. The pulsed magnetic fusion system of any of specific examples 33-37, wherein plate (e.g., disk) transmission region is immersed in a tank containing the dielectric fluid.
39. The pulsed magnetic fusion system of specific example 38, wherein the dielectric fluid in the tank is not in fluid communication with the dielectric fluid of the pulse tubes.
40. The pulsed magnetic fusion system of any of specific examples 32-39, wherein the plate (e.g., disk) transmission region comprises a plurality of plates (e.g., disks), wherein a subset of the plurality of pulse tubes connect to a plate of the plurality of plates of the plate transmission region.
41. The pulsed magnetic fusion system of specific example 40, wherein the plates of the plate transmission region are electrically coupled such that the pulsed electrical current is delivered to the fusion target via distinct pairs (e.g., a single anode-cathode pair, two anode-cathode pairs, three anode-cathode pairs, four anode-cathode pairs, six anode-cathode pairs, eight anode-cathode pairs, ten anode-cathode pairs, twenty anode-cathode pairs, etc.) of anodes and cathodes.
42. The pulsed magnetic fusion system of any of specific examples 32-41, wherein a first pulse tube of the pulse tubes has a difference in length from a second pulse tube of the pulse tubes.
43. The pulsed magnetic fusion system of specific example 42, further comprising a controller configured to compensate for the difference in length between the first pulse tube and the second pulse tube.
44. The pulsed magnetic fusion system of any of specific examples 30-43, wherein the pulser is immersed in a dielectric fluid, wherein the pulser comprises a plurality of replaceable pulse generators, wherein each of replaceable pulse generator of the plurality of replaceable pulse generators is configured to be changed without draining the dielectric fluid of other replaceable pulse generators of the plurality of replaceable pulse generators.
45. The pulsed magnetic fusion system of any of specific examples 30-44, wherein the pulser comprises a plurality of pulser modules arranged in parallel, wherein each pulser module comprises a plurality of pulser stages arranged in series.
46. The pulsed magnetic fusion system of specific example 45, wherein each pulser stage of the plurality of pulser stages comprises a plurality of pulser bricks arranged in parallel and configured to discharged contemporaneously.
47. The pulsed magnetic fusion system of specific example 46, wherein each pulser brick of the plurality of pulser bricks consists of two capacitors arranged in series with a switch between the two capacitors.
48. The pulsed magnetic fusion system of any of specific examples 30-47, further comprising plasma sensors, wherein the plasma sensors are arranged between pulse tubes of the pulse tube region.
49. A fusion power plant comprising the pulsed magnetic fusion system of any of specific examples 1-48.
50. A method for operating the pulsed magnetic fusion system of any of specific examples 1-49.

We claim:

1. A pulsed magnetic fusion system, comprising:
a pulser configured to generate a pulsed electrical current;
a transmission line electrically connecting the pulser to a fusion chamber, wherein the transmission line comprises a pulse tube region and a plate transmission region; and
a fusion target comprising a fusion fuel, wherein when the fusion target is disposed within the fusion chamber and the fusion target is compressed by an electromagnetic force generated by the pulsed electrical current, driving the fusion fuel to fusion conditions.

2. The pulsed magnetic fusion system of claim 1, wherein the pulser comprises a plurality of impedance-matched Marx generators (IMGs).

3. The pulsed magnetic fusion system of claim 2, wherein each IMG of the plurality of IMGs is connected to a separate pulse tube of the pulse tube region of the transmission line.

4. The pulsed magnetic fusion system of claim 3, wherein each pulse tube comprises a first inner electrode and a second inner electrode that is concentric about the first inner electrode, wherein the first and second inner electrodes are surrounded by a metal enclosure: wherein the first inner electrode, the second inner electrode and the metal enclosure are each separated by a dielectric fluid.

5. The pulsed magnetic fusion system of claim 4, wherein the dielectric fluid is deionized water.

6. The pulsed magnetic fusion system of claim 4, wherein the pulser is immersed in a second dielectric fluid that is different from the dielectric fluid of the pulse tubes.

7. The pulsed magnetic fusion system of claim 6, wherein the second dielectric fluid is a dielectric oil.

8. The pulsed magnetic fusion system of claim 6, wherein the pulser and each pulse tube are electrically coupled at a seal preventing fluid communication between the dielectric fluid and the second dielectric fluid.

9. The pulsed magnetic fusion system of claim 4, wherein plate transmission region is immersed in a tank containing the dielectric fluid.

10. The pulsed magnetic fusion system of claim 9, wherein the dielectric fluid in the tank is not in fluid communication with the dielectric fluid of the pulse tubes.

11. The pulsed magnetic fusion system of claim 3, wherein the plate transmission region comprises a plurality of plates, wherein a subset of the plurality of pulse tubes connect to a plate of the plurality of plates of the plate transmission region.

12. The pulsed magnetic fusion system of claim 11, wherein the plates of the plate transmission region are electrically coupled such that the pulsed electrical current is delivered to the fusion target via distinct pairs of anodes and cathodes.

13. The pulsed magnetic fusion system of claim 3, wherein a first pulse tube of the pulse tubes has a difference in length from a second pulse tube of the pulse tubes.

14. The pulsed magnetic fusion system of claim 13, further comprising a controller configured to compensate for the difference in length between the first pulse tube and the second pulse tube.

15. The pulsed magnetic fusion system of claim 1, wherein the pulser is immersed in a dielectric fluid, wherein the pulser comprises a plurality of replaceable pulse generators, wherein each of replaceable pulse generator of the plurality of replaceable pulse generators is configured to be changed without draining the dielectric fluid of other replaceable pulse generators of the plurality of replaceable pulse generators.

16. The pulsed magnetic fusion system of claim 1, wherein the pulser comprises a plurality of pulser modules arranged in parallel, wherein each pulser module comprises a plurality of pulser stages arranged in series.

17. The pulsed magnetic fusion system of claim 16, wherein each pulser stage of the plurality of pulser stage comprises a plurality of pulser bricks arranged in parallel and configured to discharged contemporaneously.

18. The pulsed magnetic fusion system of claim 17, wherein each pulser brick of the plurality of pulser bricks consists of two capacitors arranged in series with a switch between the two capacitors.

19. The pulsed magnetic fusion system of claim 1, further comprising plasma sensors, wherein the plasma sensors are arranged between pulse tubes of the pulse tube region.

20. A fusion power plant comprising the pulsed fusion system of claim 1.
